(19) United States
(12) Patent Application Publication
(10) Pub. No.: US 2026/0210414 A1
(43) Pub. Date: Jul. 23, 2026

(54) SYSTEM AND METHOD FOR OPERATING A WORK MACHINE

(71) Applicant: ZF Friedrichshafen AG, Friedrichshafen (DE)

(72) Inventors: Sven Bieber, Markdorf (DE); Tobias Dieterich, Friedrichshafen (DE)

(73) Assignee: ZF Friedrichshafen AG, Friedrichshafen (DE)

(21) Appl. No.: 19/138,893

(22) PCT Filed: Nov. 20, 2023
(86) PCT No.: PCT/EP2023/082322

§ 371 Date: Jun. 13, 2025

(30) Foreign Application Priority Data
Dec. 16, 2022 (DE) 10 2022 213 793.0

(51) Int. Cl. F16D 48/06

(52) U.S. Cl. CPC F16D 48/06; F16D 2500/1045; F16D 2500/10487; F16D 2500/3022; F16D 2500/30406

(57) ABSTRACT

For a work machine having a drive device with a hydrodynamic torque converter and a powershift transmission with at least a first powershift-capable friction clutch, a method of operation includes determining a first converter slip while (a) the drive device is idling, where a transmission input shaft rotates at a constant idling speed, (b) a first friction clutch is in a first shifting state in which no torque is transmitted, and (c) a turbine wheel connected to the transmission input shaft is running at a lower speed than a pump wheel of the torque converter. An inching control operation is carried out, where a first friction clutch is activated to set the determined first converter slip such that friction partners of the at least first friction clutch are brought into frictional contact. A system, a processor, a drive train, a work machine, and a computer program product are also disclosed.

### RELATED APPLICATIONS

This application claims the benefit under 35 U.S.C. § 371 as a U.S. National Phase Application of application no. PCT/EP2023/082322, filed on 20 Nov. 2023, which claims the benefit of German Patent Application no. 10 2022 213 793.0 filed on 16 Dec. 2022, the contents of which are hereby incorporated herein by reference in their entireties.

### FIELD OF THE DISCLOSURE

The invention relates to methods and a system for operating a work machine. In particular, a processor unit, a drive train, a work machine, and a computer program product are disclosed in this context.

### BACKGROUND

Modern motor vehicles in the form of work machines can be powered by diesel engines and typically feature powershift transmissions in combination with a hydrodynamic torque converter. These torque converters are equipped with one or more powershift clutches that act as directional couplings. With such a powershift clutch, it is possible to carry out what is known as inching operation. The (main) directional couplings are designed so that they can be used for starting (gear engagement) as well as for inching operation (thermal design, number of plates, etc.).

“Inching” is a control process in a work machine with a hydraulic drive system, whereby the system implements a specific (mechanical or electronic) relationship between the brake or inching pedal position and the travel speed, which is required when one movement (e.g., the travel speed) is to be smaller than the engine speed, but a specific engine speed is required for a second movement, in particular of attachments or the like, such as forks on forklifts or buckets on wheel loaders. This tax maneuver is known as “inching.” With inching, the traction force of the drive can be adjusted from 100% to 0% as desired using a corresponding pedal.

If high drive power is required at the working hydraulics instead of at the travel drive, it is possible to decouple the travel drive. For this purpose, in multi-stage transmissions with powershift clutches, either one clutch is opened completely, or the transmitted power is set by a slipping clutch. The use of a slipping clutch for traction control with limited power consumption is called “inching.”

During “inching”, a powershift-capable multi-plate clutch is operated in a slipping state, transmitting a torque greater than or equal to 0 Nm. However, a slipping clutch heats up relatively strongly during operation, which is why the range in which the clutch can slip continuously is limited. In order to comply with the limit values for coupling capacities and to prevent damage to the coupling, it is necessary that the specified hydraulic pressure and the resulting actual pressure are essentially the same. To ensure this, a relatively high degree of measurement technology has been used to date, which ensures that the target and actual pressure at the coupling match as closely as possible. Despite vehicles being set using measurement technology, the accuracy of the work machine is not good enough during operation, which can lead to clutch failures due to excessive inch pressure.

### SUMMARY

One task of the present invention can be seen in proposing a method and system for operating a work machine with improved inching operation.

The problem is solved by the subject-matters disclosed herein. Advantageous embodiments will be apparent from the following description, and the figures.

In order to enable precise control of a powershift friction clutch used for inching operation of a work machine with as little additional measurement technology as possible, preferably none at all, the present invention proposes performing traction force modulation on the powershift transmission, which can also compensate for influences such as wear conditions, friction coefficients, and temperature. To this end, a so-called controlled inching operation is proposed, wherein a converter slip is automatically learned and is therefore suitable for various transmissions for work machines.

According to a first aspect of the invention, a method for operating a work machine comprising a drive device with a hydrodynamic torque converter and a powershift transmission with at least one first powershift-capable friction clutch, comprising the steps:
determining at least a first converter slip while
the drive device is idling, wherein a transmission input shaft that is able to be driven in rotation by a drive machine rotates at a constant idling speed,
the at least first friction clutch is in a first shifting state in which no torque is transmitted via the at least first friction clutch,
a turbine of the torque converter operatively connected to the transmission input shaft has a lower rotational speed than a pump of the torque converter;
carrying out an inching control operation, wherein the at least first friction clutch is activated to set the determined first converter slip such that friction partners of a particular friction pairing of the at least first friction clutch are brought into frictional contact with one another.

The method therefore essentially consists of two steps: first, learning an initial converter slip, and second, controlled inching operation. Converter slip is defined as the difference between the motor or pump wheel speed and the turbine wheel speed at simultaneous motor idling speed. The drive device is idling when no drive power is transmitted via the powershift transmission to the wheels of the work machine operatively connected to the transmission for the purpose of driving the latter.

The first friction clutch, at least, is to be understood as a directional clutch or inching clutch and is in the open shifting state during the learning process of the first converter slip, in any case in such a way that no torque is transmitted via this friction clutch. The converter slip can therefore be learned with the first friction clutch fully open or with the friction clutch “prepared,” so to speak. A completely open first friction clutch is to be understood as a non-activated friction clutch that has an actual pressure of 0 bar or a control current of 0 mA. A prepared friction clutch can already be activated with a certain pressure or a certain control current without transmitting any torque. In the case of a friction clutch designed as a multi-plate clutch, the friction plates may therefore be about to come into contact or already in contact but cannot transmit any torque. The converter slip should preferably be learned with the friction clutch fully open or non-activated.

A friction clutch within the meaning of the invention is designed to transmit torque between two components in a releasable manner. A friction clutch can be controlled and can transmit torque between 0% and 100% depending on the contact pressure. Torque transmission is achieved via two friction partners that form a friction pair of the friction clutch, wherein the friction partners, when pressed together by corresponding activation and/or displacement, generate friction or force closure for torque transmission.

Inching control operation within the meaning of the invention is present when an inch pedal of the work machine is 100% activated. A 100% activated inch pedal does not transmit any or no significant torque to the output. In inching control operation, at least the first friction clutch is activated in such a way that the determined or learned first converter slip is set by means of a specific setting pressure, wherein friction partners of a respective friction pairing of the at least first friction clutch are brought into frictional contact with one another This is referred to as the “touchpoint” of the friction clutch. In this case, inching control operation can be used.

The first friction clutch is preferably designed as a multi-plate clutch, wherein the respective friction partner is a plate of the multi-plate clutch. Two plates thus form a respective friction pairing, wherein the force connection is generated by axial pressure of the plates. The friction clutch can have several friction pairings, which can be combined in a known manner to form a friction package. As a result of the contact pressure, when the friction clutch is activated, a frictional force is generated across the friction surface, which, when multiplied by the mean radius of the friction surface, results in a transferable torque. The friction clutch is activated by means of conventionally known devices.

If, starting from the touchpoint, the setting pressure at the first friction clutch is only minimally increased, the speed of the turbine wheel of the torque converter is reduced. This is because any increase in pressure originating from the touchpoint pressure results in a transmitted torque. If the converter slip at the touchpoint is known, it can be deduced when the first friction clutch transmits torque depending on the change in the converter slip. The touchpoint of the first friction clutch can theoretically be determined from the design data of the respective friction clutch.

The touchpoint pressure is preferably set by setting a specific control current to activate the friction clutch. The control current generates a setting pressure that brings the friction partners into contact with each other without transmitting torque via the friction clutch. In this sense, at least the first friction clutch is activated to carry out inching control operation by setting a target control current. Targeted control of the control current sets a specific actual pressure at the first friction clutch. Depending on the converter slip, the actual pressure of the respective friction clutch can be determined without measurement technology as an indicator of converter slip.

In inching control operation, the control current of the first friction clutch is controlled so that the converter slip, previously determined to be idling, is set. The control current determined from the setpoint pressure acts as a pilot control.

The inching control operation prevents at least the first friction clutch from “idling.” The at least first friction clutch is therefore immediately ready for controlled inching operation when the driver activates the inch setting device, in particular the inch pedal, accordingly.

In one embodiment, an offset is determined based on the respective converter slip, wherein the at least first friction clutch is further activated, taking into account the respective offset, to set the determined first converter slip such that the friction partners of the respective friction pairing of the at least first friction clutch are brought into frictional contact with one another. The control current for activating the first friction clutch is thus supplemented by an additional control current resulting from the offset. The offset may have been determined in advance using measurement techniques.

The offset is a speed deviation from the converter slip, which is added to the determined converter slip, wherein the first friction clutch is activated, taking into account the determined converter slip and the offset, preferably in such a way that a minimum torque is transmitted via the first friction clutch. By also activating the first friction clutch depending on the offset, a very low torque is transmitted by the first friction clutch at the touchpoint of the first friction clutch in inching control operation. Consequently, a transmitted torque is set in particular by selecting the appropriate offset.

In inching control operation, the control current of the first friction clutch is controlled so that the converter slip, previously determined to be idling, including the specified offset, is set. The additional offset setting causes the actual pressure at the first friction clutch to be slightly increased so that the first friction clutch transmits minimal torque. The control pressure is also slightly higher than the actual pressure without taking the offset into account. The specified offset allows inching operation to be activated directly as soon as the driver presses the inch pedal accordingly.

Preferably, at least the first converter slip is determined as a function of at least one disturbance variable of the powershift transmission and/or the torque converter. Disturbance variables can include the settling behavior of the clutch linings, the condition of the clutch linings of the respective powershift clutch designed as a friction clutch, the condition of lubricants and/or coolants, the friction coefficient of the respective friction pairing of the respective powershift clutch designed as a friction clutch, and/or a lubricant temperature. The converter slip is particularly sensitive to temperature, meaning that the converter slip must be determined or learned at different temperatures. In other words, depending on the respective disturbance variable when idling, a corresponding converter slip can be determined or automatically learned.

Once the target control current has been reached, a current offset is determined. In other words, once the target control current has been reached, the controller determines a current offset so that the desired converter slip is set. A current offset is a deviation of the current from the target control current required to set the desired converter slip.

Furthermore, the respective specific current offset is preferably stored. This allows the current offset values to be used outside of inching control operation and/or after the work machine has been restarted. This means that the respective stored current offset can be used for different inching operating states. Outside of control operation, the offset is fixed Outside of control operation, an offset is output, but it is not taken into account.

In a system according to the invention for operating a drive machine comprising a drive device with a hydrodynamic torque converter and a powershift transmission with at least one first powershift-capable friction clutch, according to a second aspect of the invention, at least one first converter slip can be determined while
the drive device is idling, wherein a transmission input shaft that is able to be driven in rotation by a drive machine rotates at a constant idling speed,
the at least first friction clutch is in a first shifting state in which no torque is transmitted via the at least first friction clutch,
a turbine of the torque converter operatively connected to the transmission input shaft has a lower rotational speed than a pump of the torque converter;
and wherein an inching control operation can be carried out, wherein the at least first friction coupling can be activated to set the determined first converter slip in such a way that friction partners of a respective friction pairing of the at least first friction coupling are brought into frictional contact with one another.

Preferably, an offset can be determined on the basis of the respective converter slip, wherein the at least first friction clutch can also be activated, taking into account the respective offset, to set the determined first converter slip in such a way that the friction partners of the respective friction pairing of the at least first friction clutch are brought into frictional contact with one another.

It is preferable that at least the first converter slip can be determined as a function of at least one disturbance variable of the powershift transmission and/or the torque converter.

Furthermore, it is preferred that at least the first friction clutch can be activated to carry out inching control operation by setting a target control current.

In addition, a current offset can be specified after the target control current has been reached. Furthermore, the system preferably has a data memory that is designed to store at least the specified current offset.

It should be expressly noted that the powershift transmission may have several powershift-capable friction clutches or directional clutches within the meaning of this invention, which can carry out a respective inching control operation The powershift transmission is designed as a powershift-capable step transmission.

According to a third aspect of the invention, a processor unit is proposed, wherein the processor unit is designed to carry out the method according to the first aspect of the invention.

According to a fourth aspect of the invention, a drive train for a work machine is provided. The drive train comprises a processor unit according to the third aspect of the invention, as well as a drive device with a powershift transmission operatively connected thereto and a hydrodynamic torque converter also operatively connected thereto. The drive device is a drive motor, preferably an internal combustion engine, in particular a diesel engine, which is operatively connected to at least one wheel of a drivable axle via the powershift transmission.

According to a fifth aspect of the invention, a work machine is provided which comprises a drive device according to the fourth aspect of the invention. A work machine typically has at least one attachment that can be operated by means of the system according to the invention. The work machine is, for example, an agricultural machine such as a tractor with a shovel or fork, or a construction machine such as a mobile excavator with a shovel, or a forklift truck with a fork. Other motor vehicles with attachments that can benefit from inching operation are also conceivable.

According to a sixth aspect of the invention, a computer program product is provided containing machine-readable instructions which, when carried out on a computer and/or on a processor unit, upgrade the computer and/or the processor unit to an operating logic of the system for operating a work machine according to the second aspect of the invention, and/or cause it to carry out a method for operating a work machine according to the first aspect of the invention.

The above definitions and explanations of technical effects, advantages, and advantageous embodiments of the method according to the first aspect of the invention also apply mutatis mutandis to the system according to the second aspect of the invention, to the processor unit according to the third aspect of the invention, to the drive train according to the fourth aspect of the invention, to the work machine according to the fifth aspect of the invention, and to the computer program product according to the sixth aspect of the invention, and vice versa.

### BRIEF DESCRIPTION OF THE DRAWINGS

The following section provides further details on exemplary embodiments of the invention based on schematic drawings, with identical or similar elements being assigned the same reference symbols The figures show:

FIG. 1: a rough schematic representation of a work machine, and

FIG. 2: a diagram for the schematic illustration of a sequence of the method according to the invention for operating the work machine according to FIG. 1.

### DETAILED DESCRIPTION

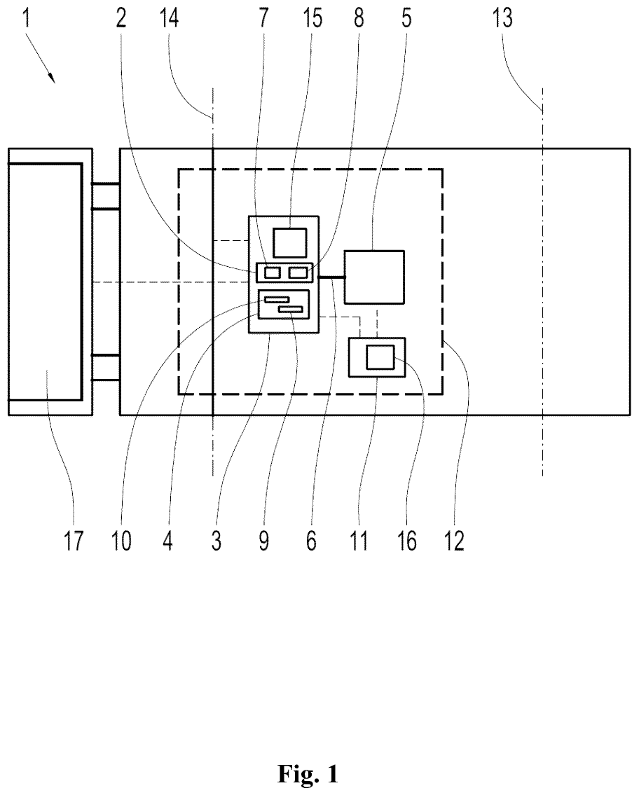

FIG. 1 shows a motor vehicle in the form of a work machine 1. The work machine 1 could be, for example, a wheel loader with a shovel as attachment 17. The work machine 1 can be operated in inching mode. The work machine 1 comprises a drive train 12, wherein the drive train 12 comprises a processor unit 11 and a drive device 5 for driving the work machine 1. The drive device 5 is, for example, an internal combustion engine in the form of a diesel engine, which is operatively connected to a powershift transmission 3 or a powershift-capable stepped transmission and a hydrodynamic torque converter 2. The exact structure of the powershift transmission 3 is not shown here. In any case, the powershift transmission 3 comprises several clutches, at least one of which is a powershift-capable friction clutch 4. This friction clutch 4 is to be understood as a directional coupling of the powershift transmission 3. With the friction clutch 4, a method according to the invention for operating the drive machine 1 can be carried out, as explained below.

The drive device 5 drives a front axle 14 via the powershift transmission 3 and, depending on the inching mode, also the attachment 17. It is conceivable that the drive device could alternatively or additionally drive the rear axle 13 of the work machine 1. Wheels, chains, or similar devices can be attached to the front axle 14 and rear axle 13 to propel the work machine 1. The powershift transmission 3 communicates with a processor unit 11 and also comprises a hydrodynamic torque converter 2. The torque converter 2 comprises a pump wheel 7 and a turbine wheel 8, which are operatively connected or can be operatively connected to a transmission input shaft 6 of the drive device 5. The torque converter 2 is part of a system according to the invention for operating a drive machine 1, wherein the friction clutch 4 can be activated in an inching control operation in such a way that “idling” of the friction clutch 4 is prevented and, conversely, the friction clutch 4 can be immediately engaged to carry out inching operation of the work machine 1.

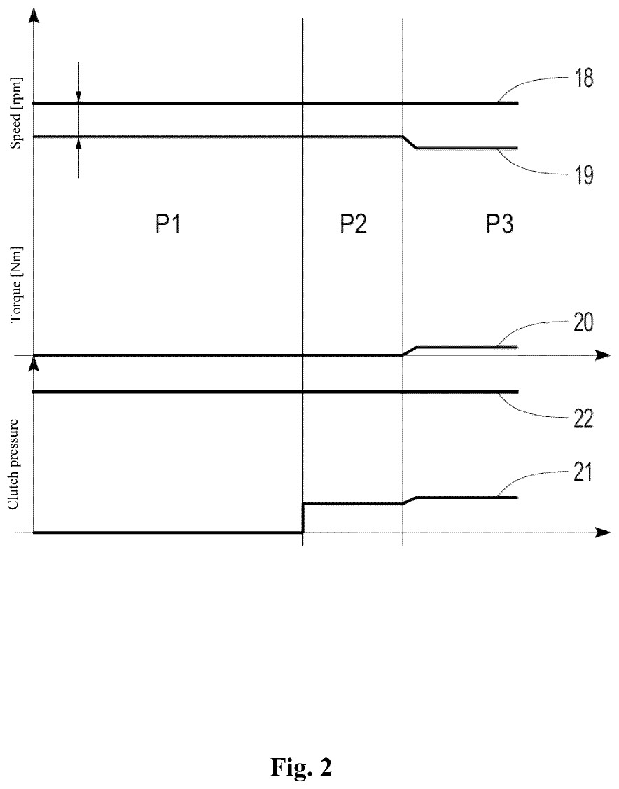

FIG. 2 shows a diagram in which, at the top, a first speed curve 18 of the pump wheel 7 or the transmission input shaft 6 and a second speed curve 19 of the turbine wheel 8 are plotted over time. In the middle of the diagram in FIG. 2, a torque curve 20 of a transmitted torque of the friction clutch 4 is plotted over time. The diagram below shows an initial pressure curve 21 for the friction clutch 4 and a second pressure curve 22 for a second friction clutch 15, which connects the powershift transmission 3 to an output or to wheels of the drive train 12. The second pressure curve 22 shows that during idling operation (phases PI and P2) and during inching control operation (phase P3), the second friction clutch 15 is closed. It can also be seen that the speed of the pump wheel 7 or the transmission input shaft 6 does not change in phases P1 through P3.

According to FIG. 2, in a first phase P1 of the method according to the invention, a converter slip is determined or automatically learned. This occurs while the drive device 5 is idling, wherein the transmission input shaft 6, which is rotated by a drive machine 1, rotates at a constant idling speed in accordance with the first speed curve 18 while the friction clutch 4 is in a completely open first shifting state, so that no torque is transmitted via the friction clutch 4, see first pressure curve 21 in phase P1. In addition, when the drive device 5 is idling, the turbine wheel 8 of the torque converter 2, which is operatively connected to the transmission input shaft 6, has a lower speed than the pump wheel 7 of the torque converter 2. The converter slip is influenced by various disturbance variables of the drive train 12, in particular of the powershift transmission 3, wherein the converter slip of the torque converter 2 is determined on the basis of these disturbance variables. Since converter slip is particularly dependent on temperature, converter slip can be determined or learned at different temperatures. For example, and for better understanding, a converter slip of 30 revolutions per minute is determined here at a lubricant temperature of 70° C. during idling operation of the drive device 5. In the first phase, P1, the converter slip is automatically learned as a reference value.

Subsequently, an inching control operation can be carried out with the drive device 5 in idling operation, in which the friction clutch 4 is initially activated to set the determined first converter slip in such a way that friction partners 9, 10 of a respective friction pairing of the friction clutch 4 are brought into frictional contact with one another. This corresponds to phase P2 and is to be understood as the “touchpoint” of friction clutch 4. The pressure is increased to a specific value in accordance with the pressure curve 21 shown in FIG. 2. At the touchpoint, each increase in the converter slip allows a transmissible torque to be detected by means of the friction clutch 4. In addition, any increase in pressure in the friction clutch 4 resulted in a transmitted torque, while the speed of the turbine wheel 8 decreased. This becomes clear in the transition area between phase P2 and phase P3.

The converter slip corresponds to a state of the friction clutch 4 in which 0 Nm of torque is transmitted. The friction clutch 4 in this case is a multi-plate clutch, wherein the friction partners 9, 10 are to be understood as plates of the multi-plate clutch in accordance with FIG. 1. Whenever the term “plates” is used below, it refers to friction partners 9 and 10, and vice versa. Similarly, whenever reference is made to a multi-plate clutch, this refers to the friction clutch 4, and vice versa. It should be noted that all types of friction-capable couplings can be used for the invention, regardless of whether they are pneumatically, hydraulically, or otherwise controlled.

Inching control operation is active when an inch setting device (not shown here), such as an inch pedal, is fully activated, i.e., no or no significant torque is transmitted to the attachment of the work machine 1. Inching control operation takes place in the third phase, P3.

In inching control operation, a target control current for the friction clutch 4 is set so that the converter slip previously determined to be idling, including an empirically determined and specified offset, is set. The slip in torque converter 2 is therefore controlled to a setpoint value. Once the converter slip is reached, the actual pressure in the friction clutch 4 can be determined from physical relationships, which is used to activate the friction clutch 4. The offset is, for example, 5 revolutions per minute, so that a control current corresponding to 35 revolutions per minute is set to activate friction clutch 4. The control current determined from the setpoint pressure serves as pilot control The additional offset setting causes the actual pressure of the friction clutch 4 to be slightly increased, which is why the friction clutch 4 transmits minimal torque. The control pressure is also slightly higher than the “0 Nm pressure.” In this example, the control pressure for setting the first converter slip or for activating the friction clutch is 4 1.5 bar, so that the friction partners 9, 10 are in contact with each other but do not transmit any torque. This pressure essentially corresponds to the spring force in the friction clutch 4.

Taking the offset into account, the friction clutch 4 is controlled to a setpoint pressure of, for example, 1.6 bar in the inching control operation. The control current for this is 220 mA. Once the target control current has been reached, the controller determines a current offset so that the desired converter slip is set. This can be stored for different inching operating states on a memory unit 16. In other words, the current used can be stored as a value on the proportional pressure controller, wherein the basic parameters for different inching operating states are used by forming a current offset Converter slip speeds can be stored on memory unit 16 depending on the aforementioned disturbance variables and used for operating states that differ from normal control operation.

The inching control operation can be carried out by means of a computer program product for operating the work machine 1, wherein the computer program product may contain corresponding program code for this purpose. For example, a controller for controlling the control current can be stored on the computer program product. The processor unit 11 can access and carry out the computer program product. For example, the computer program product may be stored on a memory unit 16 of the processor unit 11.

It should be noted that the invention works not only with a torque converter, but also with a primary clutch or a hydrostat. Only the indicators for the transmitted torque change.

Different torque converters naturally have different characteristics and converter slip speeds. The invention proposed here enables an automatic detection function for the converter slip to be implemented. By learning the converter slip speed, the converter characteristics can be learned and equalized for any transmission. Tolerances such as friction coefficients and the effects of aging on friction surfaces and lubricants can also be compensated for.

### REFERENCE NUMBERS

1 Work machine
2 Hydrodynamic torque converter
3 Powershift transmission
4 First friction clutch or multi-plate clutch
5 Drive device
6 Transmission input shaft
7 Pump wheel
8 Turbine wheel
9 First friction partner or first plate of the friction clutch
10 Second friction partner or second plate of the friction clutch
11 Processor unit
12 Drive train
13 Rear axle
14 Front axle
15 Second friction clutch
16 Memory unit
17 Attachment
18 Initial speed curve
19 Second speed curve
20 Torque curve
21 Initial pressure curve
22 Second pressure curve
P1 First phase
P2 Second phase
P3 Third phase

1. A method for operating a work machine (1) having a drive device (5) with a hydrodynamic torque converter (2) and a powershift transmission (3) with at least a first powershift-capable friction clutch (4), the method comprising the steps of:
determining at least a first converter slip while
the drive device (5) is idling, wherein a transmission input shaft (6) that is able to be driven in rotation by a drive machine (1) rotates at a constant idling speed,
the at least powershift-capable first friction clutch (4) is in a first shifting state in which no torque is transmitted via the at least first friction clutch (4),
a turbine wheel (8), operatively connected to the transmission input shaft (6), of the torque converter (2) is running at a lower speed than a pump wheel (7) of the torque converter(2); and
carrying out an inching control operation, wherein the at least first powershift-capable friction clutch is activated to set the determined first converter slip such that friction partners (9, 10) of a particular friction pairing of the at least first powershift-capable friction clutch are brought into frictional contact with one another.

2. The method according to claim 1, comprising:
determining an offset on the basis of the respective determined converter slip;
further activating the at least first powershift-capable friction clutch (4), taking into account the respective offset, to set the determined first converter slip in such a manner that the friction partners (9, 10) of the respective friction pairing of the at least first friction clutch (4) are brought into frictional contact with one another.

3. The method according to claim 1, wherein the at least first converter slip is determined as a function of at least one disturbance variable of the powershift transmission (3) and/or the torque converter(2).

4. The method according to claim 1, wherein the at least first powershift-capable friction clutch (4) is activated to carry out the inching control operation by setting a target control current.

5. The method according to claim 4, comprising determining a current offset after the target drive current is reached.

6. The method according to claim 5, comprising storing the determined current offset.

7. A system configured to carry out the method of claim 1.

8. The system according to claim 7, the system further configured for determining an offset on the basis of the respective determined converter slip, and
activating the at least first friction clutch (4), taking into account the respective offset, to set the determined first converter slip such that the friction partners (9, 10) of the respective friction pairing of the at least first friction clutch are brought into frictional contact with one another.

9. The system according to claim 7, or wherein determining the at least first converter slip is performed as a function of at least one disturbance variable of the powershift transmission (3) and/or the torque converter (2).

10. The system according to claim 7, wherein the at least first friction clutch (4) can be activated to carry out the inching control operation by setting a target control current.

11. The system according to claim 10, the system further configured to determine a current offset after the target control current has been reached.

12. A processor unit (11) comprising executable code that, when executed, carries out the method according to claim 1.

13. A drive train (12) for a work machine comprising:
a processor unit (11) comprising executable code that when executed carries out the method according to claim 1;
a drive device (5) with a powershift transmission (3) operatively connected thereto; and
a hydrodynamic torque converter (2) also operatively connected to the drive device (5).

14. A work machine (1) comprising the drive train (12) comprising:
processor unit (11) comprising executable code that when executed carries out the method according to claim 1;
a drive device (5) with a powershift transmission (3) operatively connected thereto; and
a hydrodynamic torque converter (2) also operatively connected to the drive device (5).

15. A computer program product containing machine-readable instructions which, when carried out on a computer and/or on a processor unit (11), upgrade the computer and/or the processor unit (11) carry out the method for operating a work machine according to claim 1.
